(19) United States
(12) Patent Application Publication
(10) Pub. No.: US 2023/0342975 A1
(43) Pub. Date: Oct. 26, 2023

(54) FUSION ENABLED RE-IDENTIFICATION OF A TARGET OBJECT

(71) Applicant: Anno.ai, Inc., Minnetonka, MN (US)

(72) Inventor: Matthew James Thomasson, Minnetonka, MN (US)

(21) Appl. No.: 18/179,803

(22) Filed: Mar. 7, 2023

Related U.S. Application Data
(60) Provisional application No. 63/317,278, filed on Mar. 7, 2022.
(60) Provisional application No. 63/401,449, filed on Aug. 26, 2022.

(51) Int. Cl. G06T 7/73; G06V 20/17

(52) U.S. Cl. CPC G06T 7/74; G06V 20/17; G06T 2207/10032; B64U 10/14

(57) ABSTRACT

View sensors such as cameras can be used to determine a position of a target object through any number of techniques. In some forms the view sensors can be coupled with a range estimation device such as computer vision to determine the distance of the target object from the view sensor. The position of the target object can take the form of either relative position or absolute position, and can be determined through the distance estimate as well as an angle of the target object from the view sensor. Such angle can be, for example, an azimuth. The estimate of target object position can be used with another image sensor to aid in the re-identification of the target object.

### CROSS REFERENCE TO RELATED APPLICATIONS

This application claims the benefit of U.S. Provisional Patent Application No. 63/317,278 filed Mar. 7, 2022 and entitled “Re-Identification of a Target Object,” and claims the benefit of U.S. Provisional Patent Application No. 63/401,449 filed Aug. 26, 2022 and entitled “Systems and Methods to Perform Measurements of Geometric Distances and the Use of Such Measurements,” both of which are hereby incorporated by reference in their entirety.

### TECHNICAL FIELD

The present disclosure generally relates to re-identification of a target object between different view sensors (e.g. cameras), and more particularly, but not exclusively, to position determination of a target object with a first view sensor and re-identification of the target object by a second view sensor while using the position determined using information from the first view sensor.

### BACKGROUND

Providing position information between image sensors for the purpose of target object re-identification remains an area of interest. Some existing systems have various shortcomings relative to certain applications. Accordingly, there remains a need for further contributions in this area of technology.

### SUMMARY

One embodiment of the present disclosure is a unique technique to determine position of a target object using information from a first view sensor and pass the determined position to a second view sensor for acquisition of the target object. Other embodiments include apparatuses, systems, devices, hardware, methods, and combinations for passing position information of a target object between view sensors for re-identification of the target object. Further embodiments, forms, features, aspects, benefits, and advantages of the present application shall become apparent from the description and figures provided herewith.

### BRIEF DESCRIPTION OF THE FIGURES

FIG. 1A depicts an embodiment of a system of image sensors useful in the determination of position of a target object.

FIG. 1B depicts an embodiment of a system of view sensors useful in the re-identification of a target object through sharing of position information.

FIG. 2A depicts characteristics of view sensors depicted in FIG. 1A.

FIG. 2B depicts characteristics of view sensors depicted in FIG. 1B.

FIG. 3 depicts a computing device useful with a view sensor or otherwise suitable for computation of position using information provided from a view sensor.

FIG. 4 depicts an embodiment of the of system of view sensors useful in the re-identification of a target object through sharing of position information.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

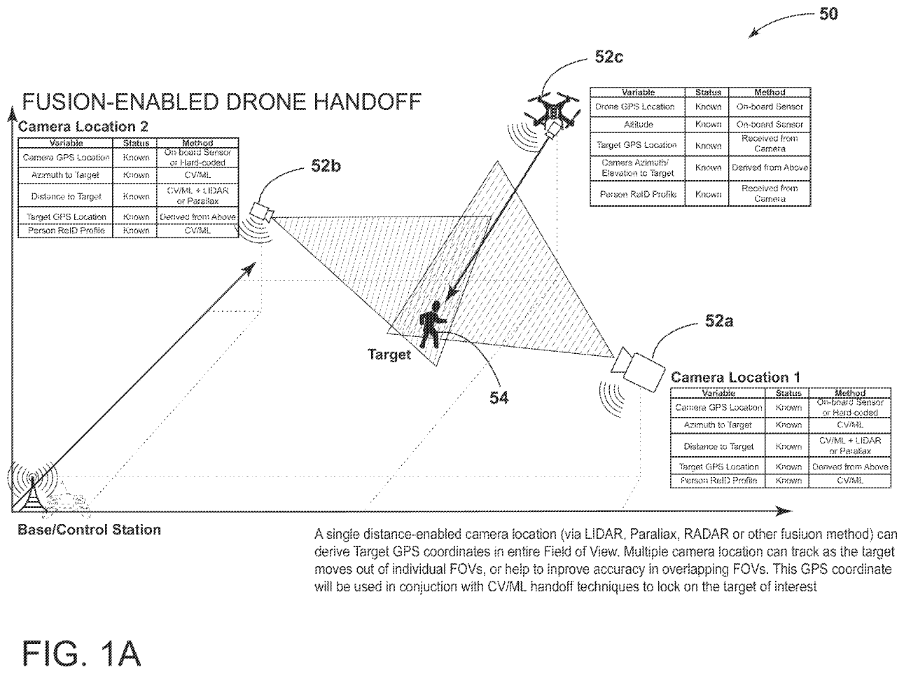

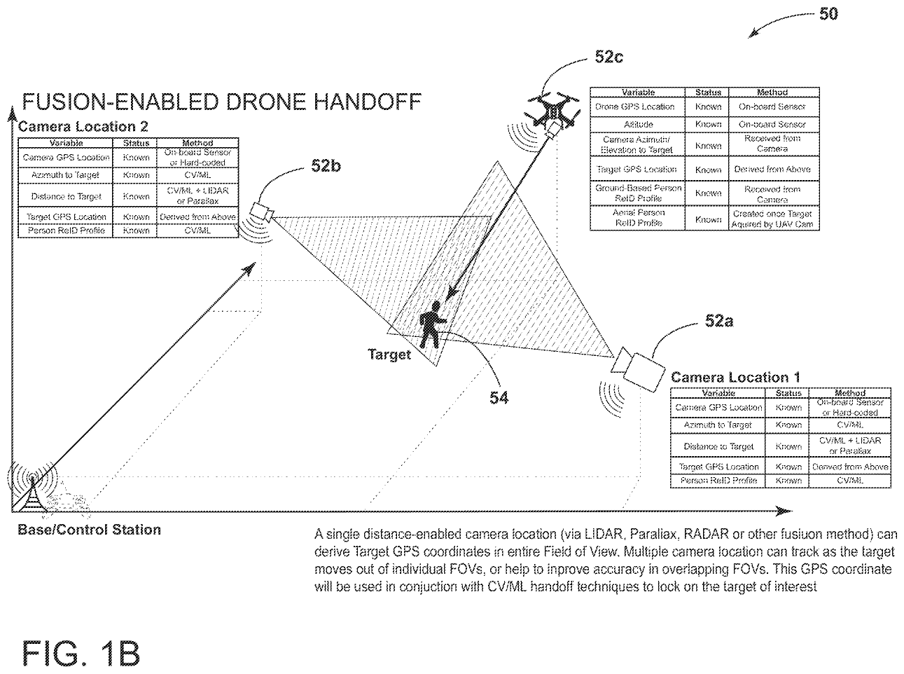

With reference to FIGS. 1A and 1B, one embodiment of a system 50 is illustrated which includes a number of view sensors 52a, 52b, and 52c used to sense the presence of a target object 54. In the case of the illustrated embodiment, the target object is a person, but in other applications of the techniques described herein any variety of objects both movable and immovable are contemplated as the target object. As will also be described further herein, information collected from the view sensors 52 can be useful in either determining position of the target object 54 in a relative or absolute sense (e.g., a latitude/longitude/elevation of the target object), or passing along information (e.g., to a server) useful to permit computation of position of the target object 54 from the particular view sensor 52. The determination of the position of the target object 54 by the view sensor 52 (or by a server or other computing device) using information from the view sensor permits said position to be passed to another view sensor for target object acquisition. For example, if a first view sensor (or server, etc.) determines the position of the target object, information of the position can be passed to a second view sensor which can consume the information for pickup of the target object 54 in its field of view. In some embodiments, an image generated by the second view sensor can be used by another computing device other than the second view sensor (e.g., using a server or other central computing device). Such pickup of the target object 54 in an image generated by the second view sensor can include inspecting a region of a field of view of the view sensor corresponding to the position, and/or maneuvering the view sensor to alter is orientation (e.g. swiveling a camera, moving the camera via a drone, etc.) and consequently move the field of view.

As will be appreciated, an image captured by a first view sensor 52, in conjunction with position enabling information collected from other sources (see further below), can aid in determining position of the target object. Determination of the position can be made at the first view sensor, or, alternatively, an image from the first view sensor can be provided to a computing device (e.g., a server) apart from the first view sensor. The position determined from the first view sensor can be used to aid in acquiring and re-identifying the target object by the second view sensor. Information of the target object contained within an image captured from the second view sensor can be used to augment information of the target object contained within the image captured by the first view sensor.

One particular embodiment of passing target object position as determined using information from a view sensor can be used to aid in re-identifying the target object in any given view sensor capable of viewing the target object. For example, in an embodiment involving an airborne drone as depicted in FIGS. 1A and 1B, that particular view sensor can be used to locate and determine the position of the target object 54, and when the target object 54 passes into view of another view sensor the position information can be used to acquire the target object with another view sensor. Such re-identification, or re-acquisition, of the target object can occur by using the position information as well as through a number of different techniques including, but not limited to, object recognition (e.g., through use of object detection and/or computer vision models trained to recognize objects). For example, if the target object is a person with a white hat, the position of the target object can be determined using the drone, and then that position can be passed and/or used with an image generated by another image sensor along with the information that the target object includes a white hat. The information related to the object, determined from an image captured by the view sensor, can include a variety of target object data including type of object (e.g., hat, person, box, etc.) and object attributes (color, size, etc.). The target object data can be stored for future use. Furthermore, such ability to distinguish the target object not only based on position but some other distinguishing characteristic can give rise to robust tracking of objects through a network of view sensors.

To set forth more details of the example immediately above, a vector profile can be created for the target object based on the image and the target object detected in the image, where the vector profile represents an identification associated with the target object. In the above example, the white hat can serve as a vector profile, as well as any other useful attribute that can be detected and/or identified from the white hat. In addition to a white hat, the color of clothes such as pants or a jacket, color of skirt, etc. could also be used in the vector profile. As will be appreciated, a vector profile can be determined through extraction of discriminative features into a feature vector. Various approaches can be used to extract the discriminative features, including, but not limited to, Omni-Scale Network (OSNet) convolutional neural network (CNN). For example, identifying a target object in an image from a first view sensor can be used to generate a first vector profile having a first feature vector associated with the extraction of discriminative features from the image created by the first view sensor. The same target object, when viewed from the second view sensor, may have an associated second vector profile generated from an image generated from the second view sensor. The second vector profile may be different from the first vector profile owing to, for example, different viewing angles and perspectives of the first view sensor and second view sensor, respectively.

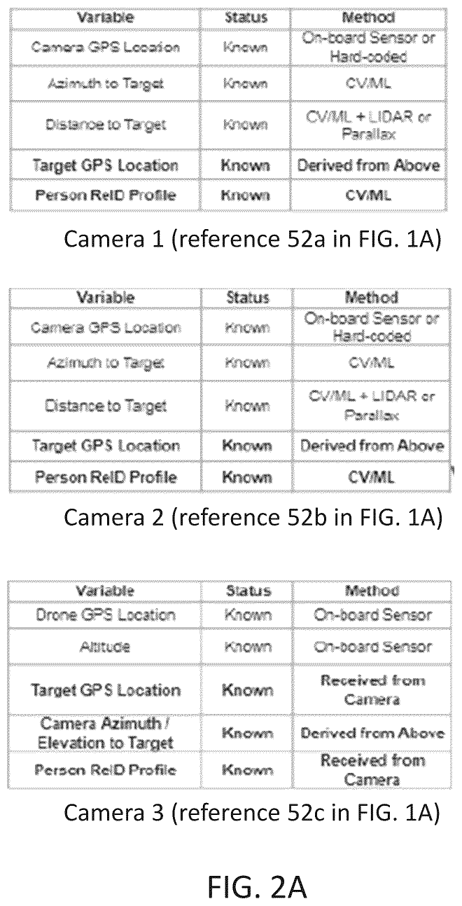

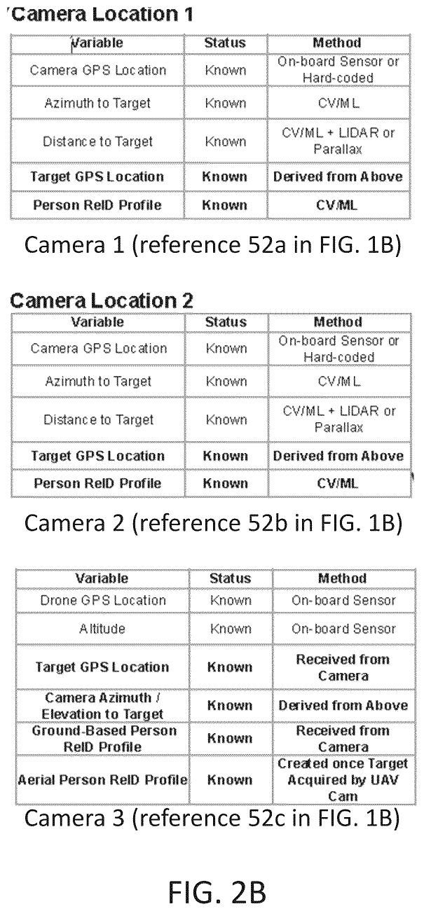

A vector profile can be passed from camera to camera (or in other examples of a central server, the vector profile can be passed to the central server for use in comparing images, or images can be passed to the central server for use in determining respective vector profiles). In the example illustrated in FIGS. 1B and 2B, and specifically the drone 52c, a vector profile in the form of a ground-based person ReID profile can be provided to the drone (or a central server), and then an aerial person ReID profile can be created given the different vantage point of the drone. See the ‘Camera 3 (reference 52c in FIG. 1B)’ portion of FIG. 2B for an example. In some forms the vantage point of the drone can create a substantially different vector profile than an entirely terrestrially based camera. The vector profile created from an airborne asset such as drone 52c can be maintained separate from a ground-based vector profile and passed among cameras (or associated with each camera and maintained by a central server), and in some instances the vector profile from the drone 52c can be used as the dominate vector profile to be passed among cameras.

The view sensors 52a, 52b, and 52c are depicted as cameras in the illustrated embodiment but can take on a variety of other types of view sensors as will be appreciated from the description herein. As used herein, the term ‘camera’ is intended to include a broad variety of imagers including still and/or video cameras. The cameras are intended to cover both visual, near infrared and infrared bands and can capture images at a variety of wavelengths. In some forms the view sensors can be 3D cameras. Although some embodiments use cameras as the view sensors, the image sensors can take on different forms in other embodiments. For example, in some embodiments the view sensors can take on the form of a synthetic aperture radar system.

As will be appreciated in the depiction of the embodiment in FIGS. 1A and 1B, the view sensors can take the form of a camera fixed in place or a drone having suitable equipment to capture images. No limitation is hereby intended as to the form, type, or location of the view sensors. For example, in some forms the view sensors can be mounted to a marine drone (surface, underwater, etc.), terrestrial drone (e.g. autonomous car, etc.), fixed in place, fixed in place but capable of being moved, etc. As used herein, the term ‘view sensor’ can refer to the platform on which an imager is coupled (e.g. drone, surveillance camera housing). Specific reference may be made further below to a ‘field of view’ or the like of the view sensor, which will be appreciated to mean the field of view of the imager used in the view sensor platform.

In some forms the cameras can include the capability to estimate, or be coupled with a device structured to estimate, a range from the respective view sensor 52 to the target object 54. The ability to estimate range can be derived using any variety of devices/schemes including laser range finders, stereo vision, LiDAR, computer vision/machine learning, etc. Any given view sensor 52 can natively estimate range and/or be coupled with one or more physical devices which together provide capabilities of sensing the presence of the target object and estimating the range of the target object from the detector. As used herein, the ‘range’ can include a straight-line distance, or in some forms can be an orthogonal distance measured from a plane in which the camera resides (as can occur with a stereo vision system, for example). Knowledge of a range of a target object from a first sensor along with information of the field of view of the camera can aid in determination a position of the target object relative to the first view sensor. If location of a second view sensor is also known relative to the first view sensor, it may also be able to determine the position of the target object relative to a field of view of the second view sensor given knowledge of an overlap of field of view of the first view sensor and second view sensor. For example, if the fields of view between the first view sensor and the second view sensor are orthogonal with the respective view sensors placed at a 45 degree angle to one another along a known distance, and if a target object is determined by a range finder relative to the first view sensor which corresponds to the target object located at a pixel (or grouping of pixels), then straightforward determination of position of the target object relative to the second view sensor can be made using trigonometry.

Additionally and/or alternatively to the above, in some forms the cameras can include the capability to, or be coupled with a device structured to determine at least one angle between the view sensor 52 and target object 54. The at least one angle between the view sensor 52 and the target object 54 can be an angle of a defined line of sight of the view sensor 52 within the field of view of the view sensor 52 (e.g. an absolute angle measured from a center of the field of view with respect to an outside reference frame), or can be an angle within the field of view relative to a defined line of sight such as the center of the field of view. A knowledge of an angle to a target object relative to one view sensor can also be used to aid in determining its position (either alone or on conjunction with a range finder) which can then be used to find the target object in another view sensor.

The at least one angle (e.g., an angle between a defined line of sight and the target object) can include azimuth information, whether a relative azimuth (e.g. bearing) or an absolute azimuth (e.g. heading angle). Alternatively and/or additionally, in some forms the at least one angle can also include pitch angle (e.g. an angle relative to the local horizontal which measures the inclined orientation of the view sensor 52). Thus, any given view sensor 52 can include one or more physical devices which together provide capabilities of sensing the presence of the target object and determining the direction of the target object from the view sensor 52. As suggested above, the at least one angle, whether azimuth or pitch, between the view sensor 52 and the target object 54 can be a relative angle or in some forms an absolute angle. If expressed as a relative angle, other information may also be provided to associate the angle to a reference frame which can assist in the computation of position of the target object 52. For example, in the case of a security camera affixed in place on a building or other structure, the orientation of the view sensor in azimuth, pitch angle, etc. can be coupled with a distance estimated between the view sensor and target object to determine a relative position of the target object.

To set forth just one non-limiting example, a view sensor 52 mounted to an airborne drone can be used to determine a position of the target object 55 through use of a range finder as well as position and orientation of the view sensor 52. A laser range finder can be bore sighted to align with a center of the field of view of the view sensor 52. A target object 55 can be positioned within the center of the field of view of the view sensor 52, a distance can be determined by the laser range finder, and the position and orientation of the view sensor 52 can be recorded. If a position of the airborne drone is known (e.g., position from a Global Positioning System output), then a position of the target object expressed in GPS geodetic coordinates can be obtained. The reverse is also contemplated: the airborne drone can be given a position of the target object 55, and a command issued to navigate the airborne drone to a vantage point that will place the position of the target object 55 within the field of view of the view sensor 52.

As noted in FIGS. 2A and 2B (which refer respectively to FIGS. 1A and 1B), an angle to the target object (denoted as azimuth in the charts depicted in FIGS. 2A and 2B, but understood herein to include other angles as well), can be determined using computer vision (CV) and/or machine learning (ML), denoted as CV/ML in the figure. The position of points within the fields of view of the view sensors 52 can be determined using CV/ML, and in some embodiments can be determined directly from the view sensor system itself (e.g., LiDAR). In these embodiments the field of view can be represented as a point cloud wherein the position of each point in the cloud is determined. If the environment of the field of view is known, such as a building or pavement, sidewalk, etc., then constraints can be applied with appropriate position information associated with the constraints to further aid in the determination of the target object position. For example, absolute position of a base of a corner of a building can be used as a fiducial from which other positions can be determined.

Furthermore, images from the one or more view sensors can be calibrated with a three-dimensional (3D) scan of the local environment such as to permit a map of correspondence between a pixel of the image and its associated 3D position (e.g., by developing a correspondence between a pixel from an image captured by a view sensor and a position within a space mapped using, for example, a LiDAR device). Each view sensor having a field of view mapped, or at least partially mapped, by a 3-D scanner can have a correspondence developed between a pixel on an image and a position, which will allow quick translation from position in an image from one view sensor to a pixel in an image from another view sensor.

It will be appreciated that determination of position information in any of the embodiments herein can be aided by calibration of one or more of the view sensors 52. Such calibration can be aided through CV/ML using any variety of techniques, including use of a fiducial in the field of view of one or more of the view sensors. Further, calibration of one view sensor 52 may be leveraged in the calibration of another view sensor 52. Use of a fiducial can permit the creation of a correspondence, or map, between an image captured by a first view sensor and position of a target object in the field of view of the image. In addition, the creation of a correspondence, or map, between an image of a target object and position of the target object in the field of view permits the ability to inspect a region of an image from the second view sensor to find the target object given the position of the target object. In other words, once a target object has been identified and its position determined from an image of a first view sensor, the position of the target object determined from the first image can be used to find the target object in an image provided from the second view sensor. In an example of a person standing upon a surface that has been scanned by a 3-D sensor (e.g., a LiDAR system), once the scan has been matched to a view from the first view sensor, the location of the foot of the person can be determined through the correspondence of the LiDAR scanned environment and the pixels of an image taken by the view sensor. The location of the person's foot, therefore, can be used in the handoff of identification from one view sensor to another.

As will be appreciated, the above techniques can be used to determine a position of the target object 54 relative to a first view sensor 52, either in a relative sense or an absolute sense. Position of the target object as determined from information generated and/or derived from the first view sensor 52 can be useful in aiding the capture of the target object by a second view sensor 52. Such image capture by the second view sensor 52 of the target object can be accomplished using either the relative or absolute position of the target object using information generated and/or derived from the first view sensor. To set forth one nonlimiting example of a determination using relative position, if the location and viewing direction of the first view sensor is known, a computing device can evaluate information from the second view sensor to ‘find’ the target object. To continue this example with a specific implementation, an algorithm can be used to project a line along the line of sight from the first view sensor 52 to a relative distance corresponding to the distance the first view sensor 52 detected the target object. After that, in the case of a movable view sensor (e.g., a camera capable of panning/tilting, camera coupled to a drone, etc.), the second view sensor 52 can be maneuvered to ‘look’ in the direction of the offset location from the first view sensor (e.g., at the point in the direction and estimated distance of the target object from the first view sensor). As will be appreciated, therefore, the relative position of the target object 54 to the first view sensor 52 can be used to move the second view sensor 52 and/or identify a line of sight within the field of view of the second view sensor that captures the target object 54.

In some embodiments, the absolute position of the view sensor 52 can also be known in some arbitrary frame of reference, such as but not limited to a geodetic reference system (e.g. WGS84). The absolute position of the target object 54 can therefore be determined using a process similar to the above, specifically deducing the absolute position of the target object using the absolute position of the first view sensor 52 and then using any appropriate technique to develop a correspondence between an image generated with the first view sensor and a position within the field of view (e.g., using an angle(s) to the target object, and using distance to the target object; using a fiducial, using a LiDAR mapping of the area and matching the coordinates of the LiDAR with specific pixels; etc.). Such determination can be made through any number of numerical and/or analytic techniques, including but not limited to simple trigonometry. As above, it will be appreciated that the determination of absolute position of the target object 54 can be accomplished either by the first view sensor 52 or some external computing resource. Once a determination of the absolute position of the target object 54 is known, the second view sensor 52 can, for example, be maneuvered to ‘look’ in the direction of the absolute position, or a portion of the image associated with the second sensor near the position can be inspected.

Alternatively and/or additionally to the embodiments above, a line of sight can be determined from within the field of view of the second view sensor corresponding to an intersection of the line of sight of the second view sensor to the target object. As will be appreciated, therefore, the absolute position of the target object 54 to the first view sensor 52 can be used to move the second view sensor 52 and/or identify a line of sight within the field of view of the second view sensor that captures the target object 54.

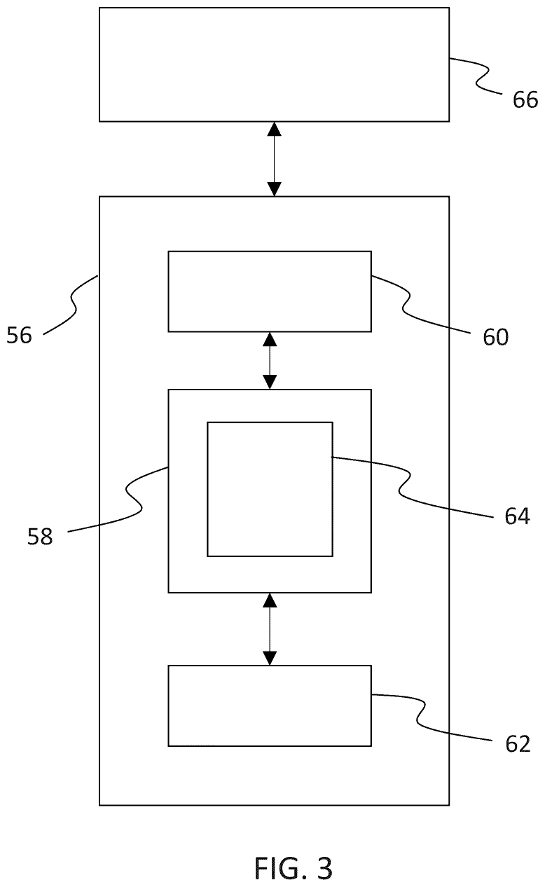

FIG. 3 depicts one embodiment of a computing device useful to provide the computational resources for the view sensors or for any device needed to collect and process data in the framework described with respect to FIG. 1. As will be appreciated, a central server can be used to collect and/or process data collected from the view sensors. The computing device, or computer, 56 can include a processing device 58, an input/output device 60, memory 62, and operating logic 64. Furthermore, computing device 56 can be configured to communicate with one or more external devices 62. In some forms the computing device can include one or more servers such as might be available through cloud computing.

The input/output device 60 may be any type of device that allows the computing device 56 to communicate with the external device 66. For example, the input/output device may be a network adapter, network card, or a port (e.g., a USB port, serial port, parallel port, VGA, DVI, HDMI, FireWire, CAT 5, or any other type of port). The input/output device 60 may be comprised of hardware, software, and/or firmware. It is contemplated that the input/output device 60 includes more than one of these adapters, cards, or ports.

The external device 66 may be any type of device that allows data to be inputted or outputted from the computing device 56. To set forth just a few non-limiting examples, the external device 66 may be another computing device, a printer, a display, an alarm, an illuminated indicator, a keyboard, a mouse, mouse button, or a touch screen display. In some forms there may be more than one external device in communication with the computing device 56, such as for example another computing device structured to transmit to and/or receive content from the computing device 50. Furthermore, it is contemplated that the external device 66 may be integrated into the computing device 56. In such forms the computing device 56 can include different configurations of computers 56 used within it, including one or more computers 56 that communicate with one or more external devices 62, while one or more other computers 56 are integrated with the external device 66.

Processing device 58 can be of a programmable type, a dedicated, hardwired state machine, or a combination of these; and can further include multiple processors, Arithmetic-Logic Units (ALUs), Central Processing Units (CPUs), Graphics Processing Units (GPU), or the like. For forms of processing device 58 with multiple processing units, distributed, pipelined, and/or parallel processing can be utilized as appropriate. Processing device 58 may be dedicated to performance of just the operations described herein or may be utilized in one or more additional applications. In the depicted form, processing device 58 is of a programmable variety that executes algorithms and processes data in accordance with operating logic 64 as defined by programming instructions (such as software or firmware) stored in memory 62. Alternatively or additionally, operating logic 64 for processing device 58 is at least partially defined by hardwired logic or other hardware. Processing device 58 can be comprised of one or more components of any type suitable to process the signals received from input/output device 60 or elsewhere, and provide desired output signals. Such components may include digital circuitry, analog circuitry, or a combination of both.

Memory 62 may be of one or more types, such as a solid-state variety, electromagnetic variety, optical variety, or a combination of these forms. Furthermore, memory 62 can be volatile, nonvolatile, or a mixture of these types, and some or all of memory 62 can be of a portable variety, such as a disk, tape, memory stick, cartridge, or the like. In addition, memory 62 can store data that is manipulated by the operating logic 64 of processing device 58, such as data representative of signals received from and/or sent to input/output device 60 in addition to or in lieu of storing programming instructions defining operating logic 64, just to name one example.

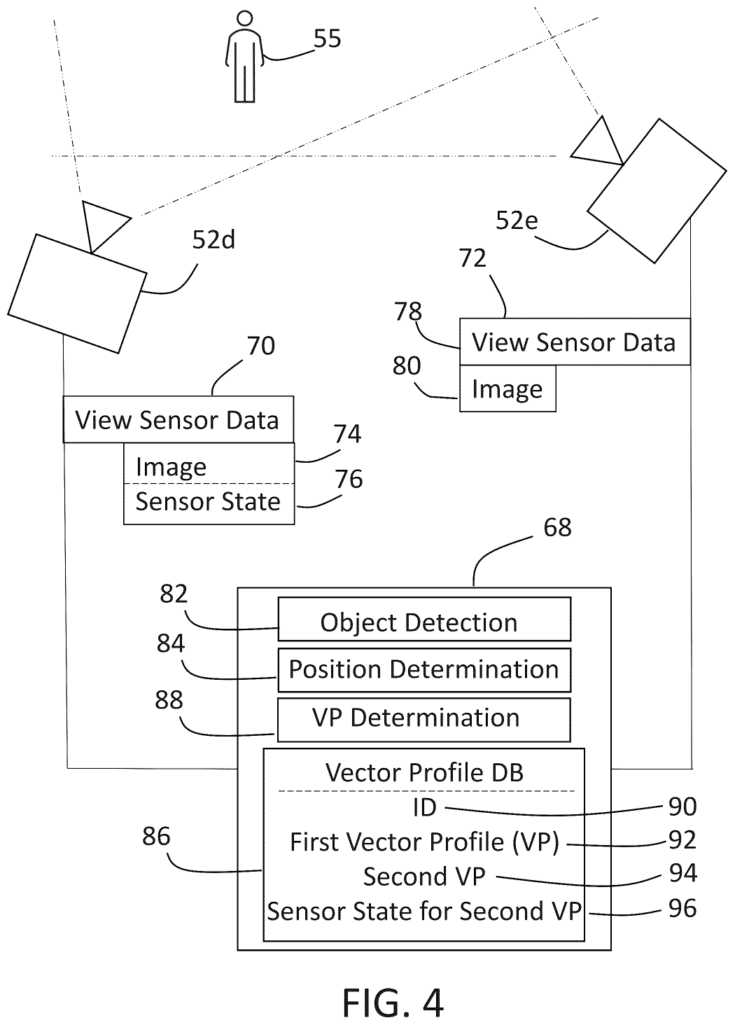

FIG. 4 depicts an embodiment that illustrates view sensors 52d and 52e capturing an image of the target object 55 in the form of a person. As above, the view sensors 52d and 52e can each take any variety of forms, including: view sensors that capture still or video images; view sensors that capture image data such as visible images or infrared images or radar images, etc.; view sensors that are fixed in place; view sensors that are capable of being manipulated from a fixed position (e.g., fixed to a wall but capable of tilt, pan, etc. movements); and view sensors that are mounted to movable platforms (e.g., drones, whether remotely controlled or autonomous, for air, sea, and/or land). In some embodiments, view sensors 52d and 52e can take on the same form (e.g., both view sensors are fixed in place), while in other embodiments the view sensors 52d and 52e can take on different forms. The view sensors 52e and 52d are capable of capturing an image and transmitting view sensor data, which includes data indicative of the image, to a central server 68 for collection and/or further computation.

The central server 68 can be in communication with the view sensors 52d and 52e either directly or through intermediate communication relays. For example, the view sensors 52d and 52e can be in communication through wired or wireless connections. In one form the central server 68 can take the form of cloud computing resource that receives view sensor data 70 and 72. In the illustrated embodiment, view sensor 52d is configured to transmit view sensor data 70 including image data 74 indicative of the image and state data 76 indicative of the sensor state. In one form the state data 76 includes operational data of the image sensor 52d such as, but not limited to, orientation data of the view sensor 52d and position information of the view sensor 52d. For example, orientation data may include a tilt angle of a view sensor 52d that is affixed to wall, or a pitch/roll/yaw angle(s) if affixed to a moving platform such as a drone. Such tilt, pan, pitch, roll, yaw, etc. angles can be measured using any variety of sensors including attitude gyros, rotary sensors, etc. In similar fashion, the position information included in the state data 76 may include a latitude/longitude/altitude of the view sensor 52d (e.g., position data available through GPS). Such state data 76 can be archived and associated with other view sensor data 70 transmitted from the view sensor 52d and/or processed from the view sensor data 70 (e.g., archiving state data 76 along with a determination of the vector profile of a target object 55 generated from the image data 74). In the illustrated embodiment, view sensor 52e is depicted as not transmitting state data 76, but it will be appreciated that other embodiments may include one or more view sensors capable of transmitting state data 76. Also in the illustrated embodiment, data related to ranging (e.g., a laser range finder that determines distance to a target object) or angle of view, etc. that may be used to aid in determining position of the target object 55 based on the image data 74 can also be provided in the sensor data 70 and/or 78 for further processing by the central server 68.

Further to the above, either or both of view sensors 52d and 52e can be capable in some embodiments of processing image data locally and transmitting processed data to the central server 68. In this respect, sensor data 70 and 72 may include additional and/or alternative information from either of image data 74 or state data 76. For example, local processing of image data can result in the view sensors 52d and/or 52e transmitting a vector profile of a target object 55 to the central server 68. The vector profile 55 may be the only information included in sensor data 70 and/or 72, or it can augment other information including, but not limited to, image data and/or state data.

In the illustrated embodiment, the central server 68 is configured to evaluate the image data 74 and detect an object within the image data 74 using object detection 82. As suggested elsewhere herein, object detection 82 can use any variety of techniques to identify the target object 55 within an image. If targes of interest are people in a given application, the object detection 82 can be specifically configured to detect the presence of people. Further, in some forms the object detection 82 can be used to aid in masking the image to identify pixels associated with the target object 55 at the exclusion of non-target object pixels. The central server 68 can also be configured to determine position of the target object through a position determination 84 which can use any one or more of the techniques described above. In this way, the position determination 84 can include a pre-determined correspondence, or mapping, between image data collected from the view sensor and the 3D local area in which the view sensor is operating.

Although the illustrated embodiment depicts the central server 68 as performing object detection 82 and position determination 84, it will be understood that the object detection 82 and position determination 84 can be accomplished local to the view sensors 52 in some embodiments. In those embodiments the sensor data may include a limited set of data transmitted from the image sensors 52d and/or 52e.

It is contemplated herein that position data of the target object 55 determined from image data 80 that includes the target object 55 can be transmitted to a vehicle having a computing device in the form of a controller. In other embodiments, however, position data of the target object 55 may be passed between view sensors 52 that are fixed in place (e.g., one view sensor fixed on a wall, the other view sensor mounted in an overhead configuration such as on an open rafter ceiling). In those embodiments where at least one view sensor 52 is moveable (e.g., a drone), the controller can be configured to issue control commands to direct the vehicle to navigate and/or orient itself into a vantage point having a field of view that can include the position corresponding to the position data determined from the image data 80. The vehicle can be a drone of any suitable configuration. In some forms, however, the view sensor 52d may not be affixed to a vehicle but rather affixed to a structured (e.g., a wall) but that the view sensor 52d is capable of tilting/panning/etc. In such an embodiment, the position data of the target object 55 determined from image data 80 that includes the target object 55 can be transmitted to a platform having a motor capable of reorienting itself to change a field of view of the view sensor 52d to capture reacquire the target object 55. Once the target object 55 is acquired by the view sensor 52d after it has reoriented and/or navigated itself to a vantage point that provides a field of view with the position of the target object 5 in it, then a vector profile can be determined from the image data 74.

In still further embodiments, position data of the target object 55 determined from image data 74 that includes the target object 55 can be used to determine whether the target object 55 is within the field of view of the view sensor 52e. Once it is determined that the target object 55 is within the field of view of the view sensor 52e, image data 80 can be collected such to acquire the target object 55 and determine a vector profile of the target object 55 using image data 80.

The central server of FIG. 4 also includes a vector profile database 86. It is contemplated that the vector profile database 86 can include a unique identifier (ID) associated with any given target object 55, along with relevant data associated with image captures of the target object 55. For example, when the target object 55 is detected by the view sensor 52e, a vector profile can be created through vector profile determination 88 using any of the techniques described herein (e.g., through use of CV/ML techniques). The first vector profile 92 can be determined from the vector profile determination 88 using image data 80 captured by the view sensor 52e. If the first vector profile 92 does not match any other vector profile stored in the vector profile database 86 (e.g., either does not match exactly the same, or does not match by failing to satisfy a threshold by which a comparison is performed), a new identification (ID) 90 can be created by the central server 68 and saved in the vector profile database 86 along with the first vector profile 92. The central server 68 can inspect image data 74 from view sensor 52d using the position determined from the position determination 84 when inspecting image data 80. The position can be used to find the target object 55 in the image data 74 generated from view sensor 52d using the position determination 84. Since the position determination 84 includes a mapping, or correspondence, between a target object 55 in an image data and the position of the target object 55, the position determination 84 can either output a position based upon an identification of the target object 55, or can output the target object based upon the position. Once the target object 55 is found in the image data 74, the vector profile determination 88 can be used to determine another vector profile 94. If the other vector profile matches the first vector profile 92 by satisfying a comparison threshold between the vector profiles, then the other vector profile can be included in the first vector profile (e.g., the first vector profile can include a plurality of data). It will be appreciated that a comparison of the vector profiles can be through use of a distance measure between the vector profiles (e.g., a distance measure determine using any variety of measures including; Euclidian distance, inner product, Hamming distance. Jaccard distance, cosine similarity, among others). If the other vector generated from the image data 74 of the target object 55 through vector profile determination 88 does not match the first vector profile (e.g., either does not match exactly the same, or does not match by failing to satisfy a comparison threshold by which a comparison is performed), a second vector profile 94 can be created which will be associated with the ID 90 to ensure both first vector profile 92 and second vector profile 94 are associated the target object 55. Such an occurrence of a mismatch between first vector profile 92 and second vector profile 94 may be the result of the second view sensor 52d having a different vantage point of the target object 55 which results in a different vector profile from the vector profile determination 88. Any data can be saved in conjunction with the second vector profile, including, but not limited to, the sensor state data 76. The complete sensor state data 76 can be saved to a sensor state 96 saved for the second vector profile 94, a subset of the sensor state data 76 can be saved, derived data from the sensor state 76 can be saved, or a combination.

Any number of additional view sensors 52 can be integrated together and/or integrated with the central server 68. The ability to track the target object 55 can be facilitated by two or more vector profiles generated by the various view sensors 52 to improve re-identification robustness. Using the vector profile database 86, an object can be tracked through different view sensors 52 and, where necessary, a new vector profile can be generated. The target object can be tracked through multiple view sensors 52, and a user display can generate robust labelling of the target object derived from the identification 90 based on the different vector profiles used for different view sensors that are associated with the same identification 90 (e.g., owing to differences in vantage point giving rise to different vector profiles).

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

We claim:

1. A method for detecting objects in sensor images, the method comprising:
determining, from a first image captured by a first view sensor, a position of a target object;
querying a feature vector database to determine a unique identifier associated with the target object;
receiving a second image captured from a second view sensor;
locating the target object in the second image using the position determined from the first image;
extracting, based on the position determined from the first image, discriminative features of the target object from the second image into a second image feature vector; and
associating the second image feature vector of the target object from the second image with the unique identifier from the feature vector database.

2. The method of claim 1, wherein the feature vector database also includes a first feature vector associated with the target object, and which further includes comparing the second image feature vector with the first feature vector from the feature vector database.

3. The method of claim 2, wherein if a comparison threshold is not satisfied as a result of the comparing the second image feature vector with the first feature vector from the feature vector database, saving the second image feature vector apart from the first feature vector such that the feature vector database associates both first feature vector and second image feature vector with the unique identifier.

4. The method of claim 3, which further includes capturing the first image with the first view sensor.

5. The method of claim 4, which further includes capturing the second image with the second view sensor, and which further includes determining a platform position and platform orientation of the second view sensor.

6. The method of claim 5, which further includes associating the second image feature vector with the platform position and platform orientation.

7. The method of claim 1, wherein the position of the target object is determined from the first image on the basis of a mapping between the first image and a fiducial common between the first view sensor and the second view sensor.

8. The method of claim 1, wherein the position of the target object is expressed in geodetic coordinates.

9. A non-transitory computer-readable medium storing one or more instructions that, when executed by one or more processors, are configured to cause the one or more processors to perform operations comprising:
determining, from a first image captured by a first view sensor, a position of a target object;
querying a feature vector database to determine a unique identifier associated with the target object;
receiving a second image captured from a second view sensor;
locating the target object in the second image using the position determined from the first image;
extracting, based on the position determined from the first image, discriminative features of the target object from the second image into a second image feature vector; and
associating the second image feature vector of the target object from the second image with the unique identifier from the feature vector database.

10. The non-transitory computer-readable medium of claim 9, which further includes:
receiving, from the first view sensor, the first image;
extracting discriminative features of the target object from the first image into the first feature vector; and
wherein the feature vector database also includes the first feature vector associated with the target object.

11. The non-transitory computer-readable medium of claim 10, which further includes comparing the second image feature vector with the first feature vector, wherein if a comparison threshold is not satisfied as a result of the comparing the second image feature vector with the first feature vector from the feature vector database, saving the second image feature vector apart from the first feature vector such that the feature vector database associates both first feature vector and second image feature vector with the unique identifier.

12. The non-transitory computer-readable medium of claim 11, which further includes receiving a platform position and platform orientation of the second view sensor associated with the second image.

13. The non-transitory computer-readable medium of claim 12, which further includes associating, in the feature vector database, the second image feature vector with the platform position and platform orientation.

14. The non-transitory computer-readable medium of claim 9, which further includes:
receiving a third image captured from a second view sensor;
locating the target object in the third image using the position determined from the first image;
extracting, based on the position determined from the first image, discriminative features of the target object from the third image into a third image feature vector; and
associating the third image feature vector of the target object from the third image with the unique identifier from the feature vector database.

15. The method of claim 9, which further includes transmitting the position of the target object to a moving vehicle having the second view sensor.

16. A system comprising:
one or more processors; and
one or more computer-readable media storing instructions that, when executed by one or more processors, are configured to cause the one or more processors to perform operations comprising:
determining, from a first image captured by a first view sensor, a position of a target object;
querying a feature vector database to determine a unique identifier associated with the target object;
receiving a second image captured from a second view sensor;
locating the target object in the second image using the position determined from the first image;
extracting, based on the position determined from the first image, discriminative features of the target object from the second image into a second image feature vector; and
associating the second image feature vector of the target object from the second image with the unique identifier from the feature vector database.

17. The method of claim 16, which further includes transmitting the position of the target object to a moving vehicle having the second view sensor.

18. The method of claim 17, which further includes maneuvering the moving vehicle such that the target object is within a field of view of the second view sensor.

19. The method of claim 18, which further includes determining a platform position and platform orientation of the second view sensor that corresponds with the second image.

20. The method of claim 19, which further includes associating the second image feature vector with the platform position and platform orientation in the feature vector database.
